(19) United States
(12) Patent Application Publication
(10) Pub. No.: US 2025/0245601 A1
(43) Pub. Date: Jul. 31, 2025

(54) METHOD FOR PERFORMING QUALITY CONFORMANCE SAMPLING INSPECTION OF COMMODITIES BASED ON PRIOR INFORMATION AND ITS SYSTEM

(71) Applicant: China National Institute of Standardization, Beijing (CN)

(72) Inventors: Jing Zhao, Beijing (CN); Xuan Zhang, Beijing (CN); Gang Wu, Beijing (CN); Fan Zhang, Beijing (CN); Yunhong Zhang, Beijing (CN)

(21) Appl. No.: 18/829,476

(22) Filed: Sep. 10, 2024

(30) Foreign Application Priority Data
Jan. 25, 2024 (CN) 202410103699.8

(51) Int. Cl. G06Q 10/0639

(52) U.S. Cl. CPC G06Q 10/06395

(57) ABSTRACT

The present invention involves the field of commodity sampling inspection technology, particularly discloses a method for performing quality conformance sampling inspection of commodities based on prior information and its system, comprising: obtaining a set of prior information of each commodity available on the platform, analyzing prior characteristic values of each commodity for sale, obtaining constrained sampling data of the commodity, processing and screening unqualified sampled commodities to provide intelligent assistant management prompts. It solves the problem that the existing methods for sampling inspection of commodities sold the platform are limited to conducting equal proportion sampling under immobilized condition without analysis of prior information, while improves the accuracy and efficiency of the quality conformance sampling inspection of commodities for sale effectively by analyzing and generating constrained sampling data, thereby reducing the cost of sampling inspection, and providing preferable intelligent assistant management prompts for qualified levels of commodities for sale.

### CROSS-REFERENCE TO RELATED APPLICATION

This application claims priority of Chinese Patent Application No. 202410103699.8, filed on Jan. 25, 2024, the entire contents of which are incorporated herein by reference.

### TECHNICAL FIELD

The present invention relates to the field of commodity sampling inspection technology, specifically focusing on a method for performing quality conformance sampling inspection of commodities based on prior information and its system.

### BACKGROUND TECHNOLOGY

Sampling inspection refers to an important management method for guaranteeing the quality and compliance of commodity sold through quality conformance sampling inspection. Sampling inspection is conducive to ensuring that commodity for sale meet preset quality standards, and effectively monitoring the quality level of commodity. In addition, it can detect potential problems and defects as soon as possible, thereby reducing the risks caused by these potential quality problems, such as returns and customer complaints. Hence, it is essential to develop appropriate methods for performing quality conformance sampling inspection of commodities, so as to utilize resources more economically and efficiently while ensuring quality.

Taking the invention patent (publication number: CN111612340B) as an example, which disclosed a sampling method for performing quality conformance inspection of commodities for online sales based on big data. Specifically speaking, the process of calculating the sentiment score of certain similar commodities consist of: collecting online sales links of the commodities belonging to the same category from the network platform and the corresponding data information, including brand data, comment data, and sales volume data; performing sentiment analysis on each comment of each collected network link by employing the sentiment tendency analysis method based on the comment analysis dictionary, then, calculating the sentiment score of each comment posted on each network link for selling such commodities; in addition, based on the sentiment score of each comment posted on each network link, calculating the sentiment scores of commodities available on each network link. The present invention could obtain relatively suitable sampling probability and quantity in various complex online sales scenarios, especially in case that the total number of commodities were uncertain, thereby supporting the quality monitoring or sampling with clearer objectives, improved efficiency, and scientifically sound approaches.

Taking the invention patent (publication number: CN103761656B) as an example, which disclosed a method for performing printing inspection of commodity information and its device, comprising: encrypting and segmenting the commodity information firstly to generate two unique corresponding half codes followed by storing one half code in the database, and printing the other half code as anti-counterfeiting information on the label. Meanwhile, working out the offer value of the commodity information, which would be printed as a mark on the commodity, by employing one-way function and; after that, obtaining the label image information and the mark image information on the inspected product during inspection, and extracting the commodity information half code and the offer value of commodity information contained therein; Finally, the extracted commodity information half code was combined with the unique corresponding half code in the database to calculate the commodity information and the offer value of commodity information, and thus completing the inspection of commodity information by comparing the said data with the extracted offer value of commodity information. In general, it can efficiently authenticate the commodity information and significantly enhance the security of the information of inspected commodities, thereby yielding a strong anti-counterfeiting effect.

Based on the aforesaid scheme, there are also some shortcomings in performing quality conformance sampling inspection of commodities for sale. Specifically speaking, the existing methods are limited to proportional sampling without prior information analysis of commodity for sale. Therefore, it is impossible to know the historical defect degree of the commodity, resulting in the failure of appropriate sampling optimization and improvement based on the prior information of commodities for sale. Therefore, these methods impact the accuracy of quality conformance sampling inspection of commodity and indirectly lead to an increase in the cost of sampling inspection, hindering effective improvement in efficiency of sampling inspection of commodity.

### SUMMARY OF THE INVENTION

In response to the shortcomings of existing technology, the present invention provides a method for performing quality conformance sampling inspection of commodities based on prior information and its system, which can effectively solve the problems involved in the aforesaid background technology.

For the purpose of achieving the above objectives, the present invention is implemented through the following technical scheme: the first aspect of the present invention provides a method for performing quality conformance sampling inspection of commodities based on prior information, including: obtaining a set of prior information of each commodity available on the platform, and analyzing the prior characteristic values of each commodity for sale.

Obtaining the constrained sampling data of each commodity for sale through the analysis of the prior characteristic values of each commodity for sale.

Processing and screening the unqualified sampled commodity to provide intelligent assistant management prompts based on the constraint sampling data of each commodity for sale. As a further method, the set of prior information of each commodity for sale includes the prior production data and the prior marketing feedback data, wherein, the prior production data include the ex-factory pass rate of quality inspection and the damage rate of production line. In addition, the prior marketing feedback data include the return rate, the average bytes of negative comments, the proportion of negative comments, the sales volume, and the sales amount generated during the prior period.

As a further method, the prior characteristic values of each commodity for sale, which are utilized to integrate and quantify the prior information of each commodity for sale, can be obtained through comprehensive numerical analysis of the prior production data and the prior marketing feedback data of each commodity for sale, thereby providing the analysis basis for the constrained sampling data of each commodity for sale.

As a further method, the specific calculation formula for the prior characteristic values of each commodity for sale is:

$${λ}_{j} = \sqrt{{λ}_{j 1} * {v}_{1} + {λ}_{j 2} * {v}_{2}} .$$

Wherein, λⱼ represents the prior characteristic value of the j^{th} commodity for sale, λⱼ₁ and λⱼ₂ represent the prior characteristic value of production and the prior characteristic value of marketing feedback of the j^{th} commodity for sale respectively, in addition, v₁ and v₂ represent the weight factors of the given prior characteristic value of production and the prior characteristic value of marketing feedback, and j represents the serial number of each commodity for sale, i.e., j=1, 2, 3, . . . , j′, j′ represents the total number of commodity for sale.

As a further method, the analysis process of obtaining the constrained sampling data of each commodity for sale is as follows: calculating the preset sampling number and the preset evaluation threshold for passing sampling inspection of each commodity for sale according to the prior characteristic values of each commodity for sale.

Comparing the prior characteristic values of each commodity for sale with the reference prior characteristic values stored in the sales platform database.

If the prior characteristic values of certain commodity for sale are lower than the reference prior characteristic values, such commodity shall be recorded as the first inspected commodity, and the prior characteristic deviation values of each first inspected commodity shall be calculated. Then, by comparing these values with the reference sampling increment and the reference increase threshold for passing inspection of the first inspected commodity within a range of prior characteristic deviation values stored in the sales platform database, the reference sampling increment and the reference increase threshold for passing inspection of each first inspected commodity can be obtained, and the preset sampling number and the preset evaluation threshold for passing sampling inspection of each first commodity for sale shall be extracted. After that the fixed sampling number and the evaluation threshold for fixed samples passed inspection of each first inspected commodity, which can be utilized as the constrained sampling data of the first inspected commodity, can be obtained by accumulating the extracted preset sampling number and the preset evaluation threshold for passing sampling inspection successively.

If the prior characteristic values of certain commodity for sale are equal to the reference prior characteristic values, such commodity shall be recorded as the second inspected commodity, and the preset sampling number and the preset evaluation threshold for passing sampling inspection of the second inspected commodity, which can be utilized as the constrained sampling data of the second inspected commodity, can be obtained.

If the prior characteristic values of certain commodity for sale are larger than the reference prior characteristic values, such commodity shall be recorded as the third inspected commodity, and the prior characteristic deviation values of each third inspected commodity shall be calculated. Then, by comparing these values with the reference sampling decrement and the reference decrease threshold for passing inspection of the third inspected commodity within a range of prior characteristic deviation values stored in the sales platform database, the reference sampling decrement and the reference decrease threshold for passing inspection of the third inspected commodity can be obtained, and the preset sampling number and the preset evaluation threshold for passing sampling inspection of each third commodity for sale shall be extracted. After that the fixed sampling number and the evaluation threshold for fixed samples passed inspection of each third inspected commodity, which can be utilized as the constrained sampling data of the third inspected commodity, can be obtained by subtracting the extracted preset sampling number and the preset evaluation threshold for passing sampling inspection of the third inspected commodity successively.

As a further method, the specific process of processing and screening unqualified sampled commodity for providing intelligent assistant management prompts is as follows: calculating the sampling inspection data of each first, second and third inspected commodity, respectively, which include the 3D scanning images of samples and the integrated quality inspection information of samples;

Wherein, the integrated quality inspection information of samples includes: the color values of collection points under each humidity inspection constraint condition, the lengths of and the contours of the deformed acquisition and inspection line under each temperature inspection constraint condition, as well as the weights of quality inspection.

Extracting the reference 3D scanning images of validation of each first, second and third inspected commodity from the sales platform database, and then, extracting the sets of sampling inspection difference of each first, second and third inspected commodity through comparison in sequence, including: the offset of the center point position of each component, the total length of deviation of the outer edge contour.

Extracting the quality inspection information of samples based on integrated comparison of each first, second and third inspected commodity from the sales platform database, including the reference color values of collection points under each humidity inspection constraint condition, the defined lengths of and the reference contours of the deformed acquisition and inspection line under each temperature inspection constraint condition, as well as the weights of quality inspection validation.

Calculating the maximum offset widths of the acquisition and inspection line of each first, second and third inspected commodity under each temperature inspection constraint condition through comparison of the contours of the deformed acquisition and inspection line with the corresponding reference contours of the deformed line under each temperature inspection constraint condition.

Completing numerical fitting processing according to the sets of sampling inspection difference, the integrated quality inspection information of samples, and the quality inspection information of samples based on integrated comparison of each first, second and third inspected commodity, and thus, the evaluation values of sampling inspection qualified levels of the said first, second and third inspected commodity can be obtained.

Comparing the evaluation values of sampling inspection qualified levels of each first, second and third inspected commodity with the corresponding evaluation threshold for sampling inspection qualified levels. If the evaluation values of sampling inspection qualified levels of each first, second and third inspected commodity are lower than the corresponding evaluation threshold for sampling inspection qualified levels, such commodity shall be uniformly labelled as unqualified sampling commodity, thereby providing intelligent assistant management prompts.

As a further method, the computational formula of the evaluation values of sampling inspection qualified levels of each first, second and third inspected commodity is:

$$\{ \begin{matrix}{δ}_{i} = {α}_{i} * {τ}_{1} + {β}_{i} * {τ}_{2} \\ {δ}_{q} = {α}_{q} * {τ}_{3} + {β}_{q} * {τ}_{4} \\ {δ}_{n} = {α}_{n} * {τ}_{5} + {β}_{n} * {τ}_{6}\end{matrix} .$$

Wherein, δ₁, δ_{q} and δₙ represent the evaluation values of sampling inspection qualified levels of the i^{th} first inspected commodity, the q^{th} second inspected commodity, and the n^{th} third inspected commodity, respectively, βᵢ and αᵢ represent the evaluation values of the appearance and integrated inspection qualified level of the first inspected commodity i, respectively, β_{q} and α_{q} represent the evaluation values of the appearance and integrated inspection qualified level of the second inspected commodity q, respectively, in addition, Bₙ and αₙ represent the evaluation values of the appearance and integrated inspection qualified level of the second inspected commodity n, respectively. τ₁ and τ₂ represent the given weight factors of the appearance and integrated inspection qualified level of the first inspected commodity, respectively, τ₃ and τ₄ represent the given weight factors of the appearance and integrated inspection qualified level of the second inspected commodity, respectively, τ₅ and τ₆ represent the given weight factors of the appearance and integrated inspection qualified level of the third inspected commodity, respectively. Furthermore, i represents the serial number of each first inspected commodity, i.e., i=1, 2, 3, . . . , i′, and i′ represents the total number of the first inspected commodity, q represents the serial number of each second inspected commodity, i.e., q=1, 2, 3, . . . , q′, and q′ represents the total number of the second inspected commodity, in addition, n represents the serial number of each third inspected commodity, i.e., n=1, 2, 3, . . . , n′, and n′ represents the total number of the third inspected commodity.

As a further method, the evaluation values of the sampling inspection qualified levels of the first inspected commodity, which are utilized to integrate and quantify the sampling inspection qualified levels of each first inspected commodity, can be obtained through comprehensive numerical analysis of the 3D scanning images and the quality inspection information of samples based on integrated comparison, thereby providing the analysis basis for determining the sampling inspection qualified levels of the first inspected commodity.

The evaluation values of the sampling inspection qualified levels of the second inspected commodity, which are utilized to integrate and quantify the sampling inspection qualified levels of each second inspected commodity, can be obtained through comprehensive numerical analysis of the 3D scanning images and the quality inspection information of samples based on integrated comparison, thereby providing the analysis basis for determining the sampling inspection qualified levels of the second inspected commodity;

The evaluation values of the sampling inspection qualified levels of the third inspected commodity, which are utilized to integrate and quantify the sampling inspection qualified levels of each third inspected commodity, can be obtained through comprehensive numerical analysis of the 3D scanning images and the quality inspection information of samples based on integrated comparison, thereby providing the analysis basis for determining the sampling inspection qualified levels of the third inspected commodity.

The present invention provides a system of quality conformance sampling inspection of commodities based on prior information, including: the prior information acquisition module, which is utilized to obtain a set of prior information of each commodity available on the platform and analyze the prior characteristic values of each commodity for sale.

The constrained sampling data acquisition module, which is utilized to obtain the constrained sampling data of each commodity for sale through analysis according to the prior characteristic values of the said commodity.

The assistant management prompt evaluation module, which is utilized to process and screen unqualified samples based on the constraint sampling data of each commodity for sale for providing intelligent assistant management prompts.

The sales platform database, which is utilized to store the reference prior characteristic values, the reference sampling increment and the reference increase threshold for passing inspection of the first inspected commodity within a range of prior characteristic deviation values, the preset sampling number and the preset evaluation threshold for passing sampling inspection of the second inspected commodity, the reference sampling decrement and the decrease threshold for passing inspection of the third inspected commodity within a range of prior characteristic deviation values, and the reference color value of collection point under each humidity inspection constraint condition, the defined length of and the reference contours of the deformed acquisition and inspection line under each temperature inspection constraint condition, as well as the weight of quality inspection validation and the evaluation threshold for passing sampling inspection.

Compared to the prior art, the embodiments of the present invention have at least the following advantages or beneficial effects: (1) Relying on providing a method for performing quality conformance sampling inspection of commodities based on prior information and its system, the present invention establishes an appropriate method for performing quality conformance sampling inspection of commodities based on prior information, which is able to analyze the sets of prior information of each commodity available on the sales platform, and thus contribute to accurately determining the historical defect degree of the said commodity. It facilitates the implementation of rational sampling optimization and enhancement based on the prior information of the commodity for sale, thereby improving the accuracy of performing quality conformance sampling inspection of each commodity for sale and the overall quality of the said commodity.

(2) The present invention can reduce the cost of performing quality conformance sampling inspection of commodities and improve the efficiency of sampling inspection practically through obtaining and analyzing the constrained sampling data as well as performing targeted quality conformance sampling inspection. This not only enhances customer satisfaction and loyalty but also enables more economical and efficient resource utilization while guaranteeing quality.

(3) Based on the analysis of the prior characterization values of each commodity for sale, the present invention not only contributes to timely identification and resolution of potential quality issues of each commodity for sale, thereby improving the quality of the said commodity, but also facilitates optimization of supply chain management for each commodity for sale, so as to ensure the stability and reliability of the supply chain of the said commodity.

### BRIEF DESCRIPTION OF THE DRAWINGS

Further illustration of the present invention can be made by utilizing the accompanying drawings, however, all the embodiments described in the drawings do not constitute any limitation on the present invention. For ordinary technical personnel in the art, other drawings can be obtained based on the following drawings without creative labor.

FIG. 1 is a process diagram of the implementation steps of the present invention.

FIG. 2 is a schematic diagram of the system module connection of the present invention.

FIG. 3 is a schematic diagram of the deformation contour of the acquisition and inspection line according to an embodiment of the present invention.

Reference Marks of Drawings: 1. Reference Deformation Contour of Line; 2. Deformation Contour of Acquisition and Inspection Line; 3. Longest Offset Line

### DETAILED DESCRIPTION OF THE EMBODIMENT

The text below will provide a clear and complete description of the technical scheme employed in the embodiments of the present invention, in conjunction with the accompanying drawings. It is evident that the embodiment described is only a part, not the whole, of the present invention. On the basis of the embodiment of the present invention, all other embodiments obtained by those of ordinary skill in the arts without creative labor shall fall within the protection of the present invention.

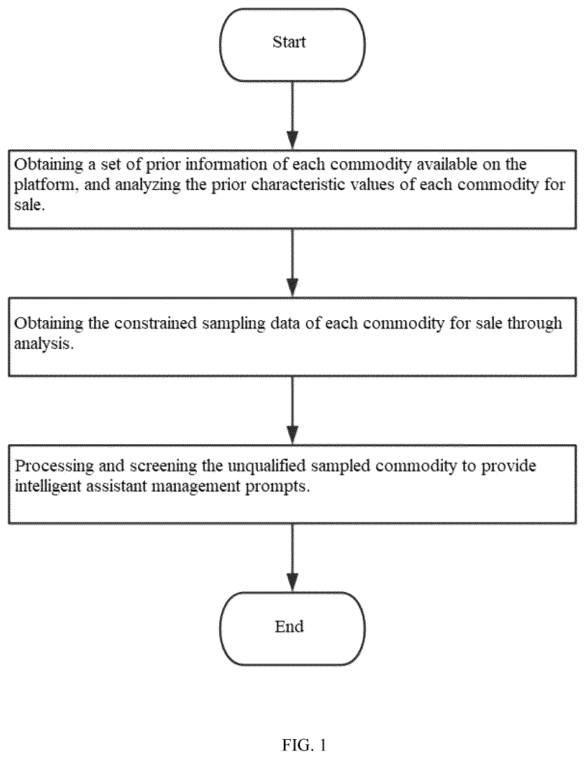

Referring to FIG. 1, the present invention provided a method for performing quality conformance sampling inspection of commodities based on prior information on the one hand, including:

S1. Obtaining a set of prior information of each commodity available on the platform, and analyzing prior characteristic values of each commodity for sale.

More precisely, the set of prior information of each commodity for sale included the prior production data and the prior marketing feedback data, wherein, the prior production data include the ex-factory pass rate of quality inspection, which referred to the rate of products that meet the specified quality standards and pass the inspection after quality inspection during the manufacturing process, i.e., the ex-factory pass rate of quality inspection=the number of qualified products/the total number of products, as well as the damage rate of production line, which referred to the rate of product damage or spoiled products caused by various reasons during the production process on the manufacturing line, i.e., the damage rate of production line=the number of damaged products/the total production. In addition, the prior marketing feedback data included the return rate generated during the prior period which referred to the proportion of commodities returned to the merchant by customers due to various reasons during the sales process, i.e., the return rate=the number of returns/the sales volume, and the average bytes of negative comments which referred to the average bytes of comments written by users among all negative comments, i.e., the average bytes of negative comments=the total bytes of negative comments/the number of negative comments, the proportion of negative comments which referred to the proportion of negative comments in all comments that users posted against the commodities for sale, i.e., the proportion of negative comments=the number of negative comments/the total number of comments, and the sales volume which referred to the total number of commodities sold during the prior period, as well as the sales amount which referred to the total amount of commodities sold during the prior period.

In a specific embodiment, the prior production data facilitated the identification of high-cost processes and the development of corresponding cost control strategies, which could assist relevant enterprises in more efficiently utilizing resources and reducing manufacturing costs during the production process. By analyzing the quality data of products, the manufacturers of various commodities for sale could identify the product defects or quality issues. In addition, such information could be utilized to improve production processes, enhance product quality, and improve customer satisfaction, as well as facilitate to be aware of the stability and efficiency of the supply chain. Furthermore, the prior marketing feedback data enabled the manufacturers to identify the strengths and weaknesses of the products by analyzing customer feedback and market research data, thereby initiating necessary improvements. Understanding customer feedback on products or services could help the manufacturers understand the market demand and trends comprehensively, and further enabled them to adjust their market positioning and strategies to meet the customer demands perfectly.

Further, the prior characteristic values of each commodity for sale, which were utilized to integrate and quantify the prior information of each commodity for sale, could be obtained through comprehensive numerical analysis of the prior production data and the prior marketing feedback data of each commodity for sale, thereby providing the analysis basis for the constrained sampling data of each commodity for sale.

Specifically speaking, the prior characteristic values of each commodity for sale could be obtained not only by further analyzing the weight factors of the prior characteristic values of production and the prior characteristic values of marketing feedback through the integrated machine learning models, but also by combining the prediction results of multiple basic models based on employing integrated methods such as the Naive Bayes model or the Random Forest model to obtain more accurate prior characteristic values of the commodities for sale. In addition, the said prior characteristic values could be worked out through by combining the weight factors of the prior characteristic values of production and marketing feedback, wherein, the specific formula for calculating the prior characteristic values of each commodity was:

$${λ}_{j} = \sqrt{{λ}_{j 1} * {v}_{1} + {λ}_{j 2} * {v}_{2}} .$$

Wherein, represented the prior characteristic value of the j^{th} commodity for sale, Δⱼ₁ and λⱼ₂ represented the prior characteristic values of production and the prior characteristic value of marketing feedback of the j^{th} commodity for sale, respectively, in addition, v₁ and v₂ represented the weight factors of the given prior characteristic value of production and the prior characteristic value of marketing feedback, respectively, and j represented the serial number of each commodity for sale, i.e., j=1, 2, 3, . . . , j′, j′ represented the total number of commodity for sale.

It should be explained that the formula of calculating the prior characteristic value of production λⱼ₁ of the j^{th} commodity for sale was:

$${λ}_{j 1} = lg ( \frac{{M}_{j}}{{M}_{j 0}} * {ω}_{1} + \frac{{N}_{j 0}}{{N}_{j}} * {ω}_{2} + 1 ) .$$

Wherein, Mⱼ and Nⱼ represented the ex-factory pass rates of quality inspection and the damage rate of production line, respectively, Mⱼ₀ and Nⱼ₀ represented the ex-factory defined pass rates of quality inspection and the defined damage rate of production line of the jth commodity for sale stored in the sales platform database, respectively, in addition, ω₁ and ω₂ represented the compensation factors of the given ex-factory defined pass rate of quality inspection and the damage rate of production line, respectively.

It should be explained that the said prior characteristic values of production of each commodity for sale were worked out based on the prior production data obtained during production, including the ex-factory defined pass rate of quality inspection and the defined damage rate of production line, which could be utilized to evaluate the prior information generated during producing each commodity for sale, thereby contributing to the analysis of quality data and guaranteeing the quality stability of the said commodity.

It should be explained that the formula of calculating the prior characteristic value of marketing feedback Δⱼ₂ of the j^{th} commodity for sale was:

$${λ}_{j 2} = {log}_{4} ( \frac{{χ}_{j 0}}{{χ}_{j}} * {ω}_{3} + \frac{{ϕ}_{j 0}}{{ϕ}_{j}} * {ω}_{4} + \frac{{ϕ}_{j 0}}{{ϕ}_{j}} * {ω}_{5} + \frac{{μ}_{j}}{{μ}_{j 0}} * {ω}_{6} + \frac{{η}_{j}}{{η}_{j 0}} * {ω}_{7} ) .$$

Wherein, χⱼ, φⱼ, ϕⱼ, μⱼ and nⱼ represented the return rate, the average bytes of negative comments, the proportion of negative comments, the sales volume, and the sales amount of the jth commodity for sale generated during the prior period, respectively, χⱼ₀, φⱼ₀, ϕⱼ₀, μⱼ₀ and ηⱼ₀ represented the defined return ratio, the reference average bytes of negative comments, the reference proportion of negative comments, the reference sales volume, and reference sales amount of the jth commodity for sale stored in the sales platform database, respectively, in addition, ω₃, ω₄, ω₅, ω₆ and ω₇ represented the compensation factors of the given return rate, the average bytes of negative comments, the proportion of negative comments, the sales volume, and the sales amount, respectively.

It should be explained that the prior characteristic values of marketing feedback for the above-mentioned commodities for sale were calculated based on the prior marketing feedback data generated during the production process of the said commodities, including the return rate, the average bytes of negative comments, the proportion of negative comments, the sales volume, and the sales amount generated during the prior period. In addition, evaluating the prior marketing data of each commodity for sale would enable sales platform personnel to comprehensively determine the strengths and weaknesses of the product, thus facilitating necessary enhancements to perfectly align with customer demands.

It should be explained that the analysis of the prior characterization values of each commodity for sale not only contributed to timely identification and resolution of potential quality issues of each commodity for sale, thereby improving the quality of the said commodity, but also facilitated optimization of supply chain management for each commodity for sale, so as to ensure the stability and reliability of the supply chain of the said commodity.

Further, the prior characteristic value of production and the prior characteristic value of marketing feedback of the commodity for sale were respectively utilized to represent the quality status after commodity inspection and the satisfaction level of customers, thereby providing the analysis basis for the constrained sampling data of each commodity for sale.

S2. Obtaining constrained sampling data of each commodity for sale through the analysis of prior characteristic values of each commodity for sale.

Further, the analysis process of obtaining the constrained sampling data of each commodity for sale was: calculating the preset sampling number and the preset evaluation threshold for passing sampling inspection of each commodity for sale according to the prior characteristic values of each commodity for sale.

Comparing the prior characteristic values of each commodity for sale with the reference prior characteristic values stored in the sales platform database.

If the prior characteristic values of certain commodity for sale were lower than the reference prior characteristic values, such commodity should be recorded as the first inspected commodity, and the prior characteristic deviation values of each first inspected commodity should be calculated. Then, by comparing these values with the reference sampling increment and the reference increase threshold for passing inspection of the first inspected commodity within a range of prior characteristic deviation values stored in the sales platform database, the reference sampling increment and the reference increase threshold for passing inspection of each first inspected commodity can be obtained, and the preset sampling number Aⱼ₀ and the preset evaluation threshold for passing sampling inspection Bᵢ₀ of each first commodity for sale should be extracted. After that the fixed sampling number and the evaluation threshold for fixed samples passed inspection of each first inspected commodity, which could be utilized as the constrained sampling data of the first inspected commodity, could be obtained by accumulating the extracted preset sampling number and the preset evaluation threshold for passing sampling inspection successively, wherein, Aᵢ referred to the fixed sampling number of the said commodity, and Aᵢ=Aᵢ₀+Aᵢ₁, in addition, Bᵢ referred to the evaluation threshold for fixed samples passed inspection of the said commodity, and Bᵢ=Bᵢ₀+Bᵢ₁, furthermore, Aᵢ₁ referred to the reference sampling increment of the said commodity, and Bᵢ₁ referred to the reference increase threshold for passing inspection of the said commodity.

If the prior characteristic values of certain commodity for sale were equal to the reference prior characteristic values, such commodity should be recorded as the second inspected commodity, and the preset sampling number A_{q0} and the preset evaluation threshold for passing sampling inspection B_{q0} of the second inspected commodity, which could be utilized as the constrained sampling data of the second inspected commodity, could be obtained. Wherein, A_{q} referred to the fixed sampling number of the said commodity, and A_{q}=A_{q0}, in addition, B_{q} referred to the fixed evaluation threshold for passing sampling inspection of the said commodity, and B_{q}=B_{q0}.

If the prior characteristic values of certain commodity for sale were larger than the reference prior characteristic values, such commodity should be recorded as the third inspected commodity, and the prior characteristic deviation values of each third inspected commodity should be calculated. Then, by comparing these values with the reference sampling decrement and the reference decrease threshold for passing inspection of the third inspected commodity within a range of prior characteristic deviation values stored in the sales platform database, the reference sampling decrement and the reference decrease threshold for passing inspection of the third inspected commodity could be obtained, and the preset sampling number Aₙ₀ and the preset evaluation threshold for passing sampling inspection Bₙ₀ of each third commodity for sale should be extracted. After that the fixed sampling number and the evaluation threshold for fixed samples passed inspection of each third inspected commodity, which could be utilized as the constrained sampling data of the third inspected commodity, could be obtained by subtracting the extracted preset sampling number and the preset evaluation threshold for passing sampling inspection of the third inspected commodity successively, wherein, Aₙ referred to the fixed sampling number of the said commodity, and Aₙ=Aₙ₀−Aₙ₁, in addition, Bₙ referred to the evaluation threshold for fixed samples passed inspection of the said commodity, and Bₙ=Bₙ₀−Bₙ₁, furthermore, Aₙ₁ referred to the reference sampling decrement of the said commodity, and Bₙ₁ referred to the reference decrease threshold for passing inspection for passing inspection of the said commodity.

In a specific implementation, different commodities for sale had different requirements for quality. Thus, by setting different constraint sampling data, the manufacturers could understand the quality standards of each commodity for sale comprehensively, and thus contributed to develop and maintain high-quality production standards. Furthermore, understanding the market performance and consumer feedback of different commodities for sale would be conducive to evaluating market risks of enterprises completely. In addition, performing constraint sampling of each commodity for sale also facilitate to predict and respond to potential market challenges.

In a specific embodiment, this method reduced the cost of performing quality conformance sampling inspection of commodities and improved the efficiency of sampling inspection practically through obtaining and analyzing the constrained sampling data as well as performing targeted quality conformance sampling inspection. In a word, it could not only enhance customer satisfaction and loyalty, but also enable more economical and efficient resource utilization while guaranteeing quality.

S3. Processing and screening unqualified samples based on the constraint sampling data of each commodity for sale for providing intelligent assistant management prompts.

More precisely, the process of processing and screening unqualified samples for providing intelligent assistant management prompts was: calculating the sampling inspection data of each first, second and third inspected commodity, respectively, which included the 3D scanning images of samples and the integrated quality inspection information of samples; wherein, the integrated quality inspection information of samples included: the color values of collection points under each humidity inspection constraint condition, which referred to the color values of collection points of each commodity for sale under different humidity inspection constraint conditions, and the lengths of deformation of the acquisition and inspection line under each temperature inspection constraint condition, which referred to the change in length of linear dimension of the preset acquisition and inspection line for the commodity for sale during temperature inspection, and the contour of deformed line, which referred to the apparent contour of the acquisition and inspection line obtained through image processing, as well as the weight of quality inspection, which referred to the weight measured during the quality inspection of each commodity for sale.

Extracting the reference 3D scanning images of validation of each first, second and third inspected commodity from the sales platform database, and then, extracting the sets of sampling inspection difference of each first, second and third inspected commodity through comparison in sequence, including: the offset of the center point position of each component, which referred to that there usually was a center point in each component of the commodity for sale, and the offset of the center point position referred to the offset of the center point of the component generated through comparison to the offset of the center point position of corresponding component in the reference 3D scanning image for validation. In a specific embodiment, the commodity for sale was clothing, which consisted of pockets, buttons, and labels, etc. In addition, the total length of deviation of the outer edge contour referred to the total deviation of the contour line after performing inspection based on overlapping the outer edge contour of each commodity for sale with the outer edge contour of the reference 3D scanning image for validation.

Extracting the quality inspection information of samples based on integrated comparison of each first, second and third inspected commodity from the sales platform database, including the reference color values of collection points under each humidity inspection constraint condition, the defined lengths of and the reference contours of the deformed acquisition and inspection line under each temperature inspection constraint condition, as well as the weights of quality inspection validation.

Calculating the maximum offset widths of the acquisition and inspection line of each first, second and third inspected commodity under each temperature inspection constraint condition through comparison of the contours of the deformed acquisition and inspection line with the corresponding reference contours of the deformed line under each temperature inspection constraint condition.

Referring to FIG. 3, the longest offset line 3 could be obtained by comparing the contour of deformed acquisition and inspection line 2 with the reference contour of deformed line 1, and thus, the maximum offset widths of the acquisition and inspection line was extracted.

Completing numerical fitting processing according to the sets of sampling inspection difference, the integrated quality inspection information of samples, and the quality inspection information of samples based on integrated comparison of each first, second and third inspected commodity, and thus, the evaluation values of sampling inspection qualified levels of the said first, second and third inspected commodity could be obtained.

Comparing the evaluation values of sampling inspection qualified levels of each first, second and third inspected commodity with the corresponding evaluation threshold for sampling inspection qualified levels. If the evaluation values of sampling inspection qualified levels of each first, second and third inspected commodity were lower than the corresponding evaluation threshold for sampling inspection qualified levels, such commodity should be uniformly labelled as unqualified sampling commodity, thereby providing intelligent assistant management prompts.

It should be explained that the aforesaid 3D scanning images provided the comprehensive morphological information of each commodity for sale, which made the evaluation of the quality of each commodity for sale more accurate. Compared with traditional 2D images or descriptions, the 3D scanning image could provide more complicated details. In addition, the integrated quality inspection information of samples referred to the data experienced systematized and standardized processing. In view of this, such objectivity was conducive to reducing the influence of subjective factors on quality evaluation and improving the reliability of evaluation. Moreover, the 3D scanning images and the quality inspection information, which usually should be recorded and archived, would be conducive to establishing a traceability and tracking system for product quality, making it easier to trace the root cause of quality issues and facilitate to developing more effective quality control strategies and improvement measures.

Further, the evaluation values of sampling inspection qualified levels of each first, second and third inspected commodity generated through numerical fitting processing could not only be obtained by further analyzing the weight factors of the evaluation values of the appearance and integrated inspection qualified levels through the integrated machine learning models, to be more specific, the more accurate evaluation values of the sampling inspection qualified levels of each first, second and third inspected commodity could be generated by combining predict results of multiple basic models based on the integrated methods including the K-means clustering model or the Support Vector Machine model, but also by calculating based on the combination of the weight factors of the evaluation values of the appearance and integrated inspection qualified levels. The specific calculation formula was:

$$\{ \begin{matrix}{δ}_{i} = {α}_{i} * {τ}_{1} + {β}_{i} * {τ}_{2} \\ {δ}_{q} = {α}_{q} * {τ}_{3} + {β}_{q} * {τ}_{4} \\ {δ}_{n} = {α}_{n} * {τ}_{5} + {β}_{n} * {τ}_{6}\end{matrix} .$$

Wherein, δ₁, δ_{q} and δₙ represented the evaluation values of sampling inspection qualified levels of the i^{th} first inspected commodity, the q^{th} second inspected commodity, and the n^{th} third inspected commodity, respectively, βᵢ and αᵢ represented the evaluation values of the appearance and integrated inspection qualified level of the first inspected commodity i, respectively, β_{q} and α_{q} represented the evaluation values of the appearance and integrated inspection qualified level of the second inspected commodity q, respectively, in addition, βₙ and αₙ represented the evaluation values of the appearance and integrated inspection qualified level of the second inspected commodity n, respectively. τ₁ and τ₂ represented the given weight factors of the appearance and integrated inspection qualified level of the first inspected commodity, respectively, τ₃ and τ₄ represented the given weight factors of the appearance and integrated inspection qualified level of the second inspected commodity, respectively, τ₅ and τ₆ represented the given weight factors of the appearance and integrated inspection qualified level of the third inspected commodity, respectively. Furthermore, i represented the serial number of each first inspected commodity, i.e., i=1, 2, 3, . . . , i′, and i′ represented the total number of the first inspected commodity, q represented the serial number of each second inspected commodity, i.e., q=1, 2, 3, . . . , q′, and q′ represented the total number of the second inspected commodity, in addition, n represented the serial number of each third inspected commodity, i.e., n=1, 2, 3, . . . , n′, and n′ represented the total number of the third inspected commodity.

It should be explained that δᵢ represented the evaluation value of the sampling inspection qualified level of the i^{th} first inspected commodity, which could be obtained through comprehensive numerical analysis of the evaluation values of the appearance and integrated inspection qualified level of the i^{th} first inspected commodity, and could be utilized to integrate and quantify the evaluation value of the sampling inspection qualified level of the i^{th} first inspected commodity, thereby providing the analysis basis for determining the sampling inspection qualified level of the i^{th} first inspected commodity.

δ_{q} represented the evaluation value of the sampling inspection qualified level of the q^{th} second inspected commodity, which could be obtained through comprehensive numerical analysis of the evaluation values of the appearance and integrated inspection qualified level of the q^{th} second inspected commodity, and could be utilized to integrate and quantify the evaluation value of the sampling inspection qualified level of the q^{th} second inspected commodity, thereby providing the analysis basis for determining the sampling inspection qualified level of the i^{th} first inspected commodity.

δₙ represented the evaluation value of the sampling inspection qualified level of the n^{th} third inspected commodity, which could be obtained through comprehensive numerical analysis of the evaluation values of the appearance and integrated inspection qualified level of the n^{th} third inspected commodity, and could be utilized to integrate and quantify the evaluation value of the sampling inspection qualified level of the n^{th} third inspected commodity, thereby providing the analysis basis for determining the sampling inspection qualified level of the n^{th} third inspected commodity.

It should be explained that the formula of calculating αᵢ, α_{q}, and αₙ was:

$$\{ \begin{matrix}{α}_{i} = \sqrt{\begin{matrix}{\sum }_{y = 1}^{{y}^{′}} \frac{{C}_{iy 0}}{\vert {C}_{{iy}^{-}} {C}_{iy 0} \vert + 1} * {ϑ}_{1} + {\sum }_{u = 1}^{{u}^{′}} ( \frac{{L}_{iu 0}}{{L}_{iu}} * {ϑ}_{2} + \frac{{Z}_{iu 0}}{{Z}_{iu}} * {ϑ}_{3} ) + \\ \frac{{W}_{i 0}}{\vert {W}_{{i}^{-}} {W}_{i 0} \vert + 1} * {ϑ}_{4}\end{matrix}} \\ {α}_{q} = \sqrt{\begin{matrix}{\sum }_{y = 1}^{{y}^{′}} \frac{{C}_{qy 0}}{\vert {C}_{qy} - {C}_{qy 0} \vert + 1} * {ϑ}_{1} + {\sum }_{u = 1}^{{u}^{′}} ( \frac{{L}_{qu 0}}{{L}_{q u}} * {ϑ}_{2} + \frac{{z}_{qu 0}}{{Z}_{q u}} * {ϑ}_{3} ) + \\ \frac{{W}_{q 0}}{\vert {W}_{q} - {W}_{q 0} \vert + 1} * {ϑ}_{4}\end{matrix}} \\ {α}_{n} = \sqrt{\begin{matrix}{\sum }_{y = 1}^{{y}^{′}} \frac{{C}_{ny 0}}{\vert {C}_{ny} - {C}_{ny 0} \vert + 1} * {ϑ}_{1} + {\sum }_{u = 1}^{{u}^{′}} ( \frac{{L}_{nu 0}}{{L}_{n u}} * {ϑ}_{2} + \frac{{z}_{nu 0}}{{Z}_{n u}} * {ϑ}_{3} ) + \\ \frac{{W}_{n 0}}{\vert {W}_{n} - {W}_{n 0} \vert + 1} * {ϑ}_{4}\end{matrix}}\end{matrix} .$$

Wherein, αᵢ represented the evaluation value of the integrated inspection qualified level of the i^{th} first inspected commodity, which could be obtained through comprehensive numerical analysis of the color values of collection points, the length of deformation and the maximum offset widths of acquisition and inspection line comprised by collection points, as well as the weight of quality inspection of the i^{th} first inspected commodity, and could be utilized to integrate and quantify the evaluation value of the integrated inspection qualified level of the i^{th} first inspected commodity, thereby providing the analysis basis for determining the integrated inspection qualified level of the i^{th} first inspected commodity.

α_{q} represented the evaluation value of the integrated inspection qualified level of the q^{th} second inspected commodity, which could be obtained through comprehensive numerical analysis of the color values of collection points, the length of deformation and the maximum offset widths of acquisition and inspection line comprised by collection points, as well as the weight of quality inspection of the q^{th} second inspected commodity, and could be utilized to integrate and quantify the evaluation value of the integrated inspection qualified level of the q^{th} second inspected commodity, thereby providing the analysis basis for determining the integrated inspection qualified level of the q^{th} second inspected commodity.

αₙ represented the evaluation value of the integrated inspection qualified level of the n^{th} third inspected commodity, which could be obtained through comprehensive numerical analysis of the color values of collection points, the length of deformation and the maximum offset widths of acquisition and inspection line comprised by collection points, as well as the weights of quality inspection of the n^{th} third inspected commodity, and could be utilized to integrate and quantify the evaluation value of the integrated inspection qualified level of the n^{th} third inspected commodity, thereby providing the analysis basis for determining the integrated inspection qualified level of the n^{th} third inspected commodity.

In addition, C_{iy}, C_{qy} and C_{ny} represented the color values of collection points under the y^{th} humidity inspection constraint condition of the i^{th} first inspected commodity, the q^{th} second inspected commodity and the n^{th} third inspected commodity, respectively, Lᵢᵤ, L_{qu} and Lₙᵤ represented the lengths of deformation of acquisition and inspection lines comprised by collection points under the u^{th} temperature inspection constraint condition of the i^{th} first inspected commodity, the q^{th} second inspected commodity and the n^{th} third inspected commodity, respectively, and Zᵢᵤ, Z_{qu} and Zₙᵤ represented the maximum offset widths of the acquisition and inspection lines comprised by collection points under the u^{th} temperature inspection constraint condition of the i^{th} first inspected commodity, the q^{th} second inspected commodity and the n^{th} third inspected commodity, respectively. In addition, Wᵢ, W_{q} and Wₙ represented the weights of quality inspection of the i^{th} first inspected commodity, the q^{th} second inspected commodity and the n^{th} third inspected commodity, respectively, C_{iy0}, C_{qy0} and C_{ny0} represented the reference color values of collection points under the y^{th} humidity inspection constraint condition of the i^{th} first inspected commodity, the q^{th} second inspected commodity and the n^{th} third inspected commodity stored in the sales platform database, respectively, Lᵢᵤ₀, L_{qu0} and Lₙᵤ₀ represented the defined lengths of deformation of acquisition and inspection lines comprised by collection points under the u^{th} temperature inspection constraint condition of the i^{th} first inspected commodity, the q^{th} second inspected commodity and the n^{th} third inspected commodity stored in the sales platform database, respectively, and Zᵢᵤ₀, Z_{qu0} and Zₙᵤ₀ represented the defined offset widths of the acquisition and inspection lines comprised by collection points under the u^{th} temperature inspection constraint condition of the i^{th} first inspected commodity, the q^{th} second inspected commodity and the n^{th} third inspected commodity stored in the sales platform database, respectively. In addition, Wᵢ₀, W_{q0} and Wₙ₀ represented the weights of quality inspection of the i^{th} first inspected commodity, the q^{th} second inspected commodity and the n^{th} third inspected commodity stored in the sales platform database, respectively. Moreover, ϑ₁, ϑ₂, ϑ₃ and ϑ₄ represented the compensation factors of the color values of collection points, the lengths of deformation of acquisition and inspection line comprised by collection points, the maximum offset widths and the weights of quality inspection. In addition, y represented the serial number of each humidity inspection constraint condition, i.e., y=1, 2, 3, . . . , y′, and y′ represented the total number of humidity inspection constraint conditions, u represented the serial number of each temperature inspection constraint condition, i.e., u=1, 2, 3, . . . , u′, u′ represented the total number of temperature inspection constraint conditions.

It should be explained that the formula of calculating βᵢ, β_{q}, and βₙ was:

$$\{ \begin{matrix}{β}_{i} = lg [ {\sum }_{e = 1}^{{e}^{′}} ( \frac{{T}_{ie 0}}{{T}_{i e}} * {ϑ}_{5} ) + \frac{{G}_{i 0}}{{G}_{i}} * {ϑ}_{6} + 1 ] \\ {β}_{q} = lg [ {\sum }_{e = 1}^{{e}^{′}} ( \frac{{T}_{qe 0}}{{T}_{q e}} * {ϑ}_{5} ) + \frac{{G}_{q 0}}{{G}_{q}} * {ϑ}_{6} + 1 ] \\ {β}_{n} = lg [ {\sum }_{e = 1}^{{e}^{′}} ( \frac{{T}_{ne 0}}{{T}_{n e}} * {ϑ}_{5} ) + \frac{{G}_{n 0}}{{G}_{n}} * {ϑ}_{6} + 1 ]\end{matrix} .$$

Wherein, βᵢ represented the evaluation value of the appearance inspection qualified level of the i^{th} first inspected commodity, which could be obtained through comprehensive numerical analysis of the offset of the center point position of and the total length of deviation of the outer edge contour of the i^{th} first inspected commodity, and could be utilized to integrate and quantify the evaluation value of the appearance inspection qualified level of the i^{th} first inspected commodity, thereby providing the analysis basis for determining the appearance inspection qualified level of the i^{th} first inspected commodity.

β_{q} represented the evaluation value of the appearance inspection qualified level of the q^{th} second inspected commodity, which could be obtained through comprehensive numerical analysis of the offset of the center point position of and the total length of deviation of the outer edge contour of the q^{th} second inspected commodity, and could be utilized to integrate and quantify the evaluation value of the appearance inspection qualified level of the q^{th} second inspected commodity, thereby providing the analysis basis for determining the appearance inspection qualified level of the q^{th} second inspected commodity.

βₙ represented the evaluation value of the appearance inspection qualified level of the n^{th} third inspected commodity, which could be obtained through comprehensive numerical analysis of the offset of the center point position of and the total length of deviation of the outer edge contour of the n^{th} third inspected commodity, and could be utilized to integrate and quantify the evaluation value of the appearance inspection qualified level of the n^{th} third inspected commodity, thereby providing the analysis basis for determining the appearance inspection qualified level of the n^{th} third inspected commodity.

In addition, Tᵢₑ, T_{qe} and Tₙₑ represented the offset of the center point position of the eth component of the i^{th} first inspected commodity, the q^{th} second inspected commodity and the n^{th} third inspected commodity, respectively, Gᵢ, G_{q} and Gₙ represented the total lengths of deviation of the outer edge contours of the eth component of the i^{th} first inspected commodity, the q^{th} second inspected commodity and the n^{th} third inspected commodity, respectively, and Tᵢₑ₀, T_{qe0} and Tₙₑ₀ represented the reference offset of the center point position of the eth component of the i^{th} first inspected commodity, the q^{th} second inspected commodity and the n^{th} third inspected commodity stored in the sales platform database, respectively, Gᵢ₀, G_{q0} and Gₙ₀ represented the reference total lengths of deviation of the outer edge contours of the i^{th} first inspected commodity, the q^{th} second inspected commodity and the n^{th} third inspected commodity stored in the sales platform database, respectively. In addition, ϑ₅ and ϑ₆ represented the compensation factors of the given offset of the center point position of and the length of deviation of the outer edge contour of each component, and e represented the serial number of each component, i.e., e=1, 2, 3, . . . , e′, e′ represented the total number of components.

Further, the evaluation values of the sampling inspection qualified levels of each first inspected commodity, which were utilized to integrate and quantify the sampling inspection qualified levels of the first inspected commodity, could be obtained through comprehensive numerical analysis of the 3D scanning images and the quality inspection information of samples based on integrated comparison, thereby providing the analysis basis for determining the sampling inspection qualified levels of the first inspected commodity;

The evaluation values of the sampling inspection qualified levels of each second inspected commodity, which were utilized to integrate and quantify the sampling inspection qualified levels of the second inspected commodity, could be obtained through comprehensive numerical analysis of the 3D scanning images and the quality inspection information of samples based on integrated comparison, thereby providing the analysis basis for determining the sampling inspection qualified levels of the second inspected commodity;

The evaluation values of the sampling inspection qualified levels of each third inspected commodity n, which were utilized to integrate and quantify the sampling inspection qualified levels of the third inspected commodity, could be obtained through comprehensive numerical analysis of the 3D scanning images and the quality inspection information of samples based on integrated comparison, thereby providing the analysis basis for determining the sampling inspection qualified levels of the third inspected commodity.

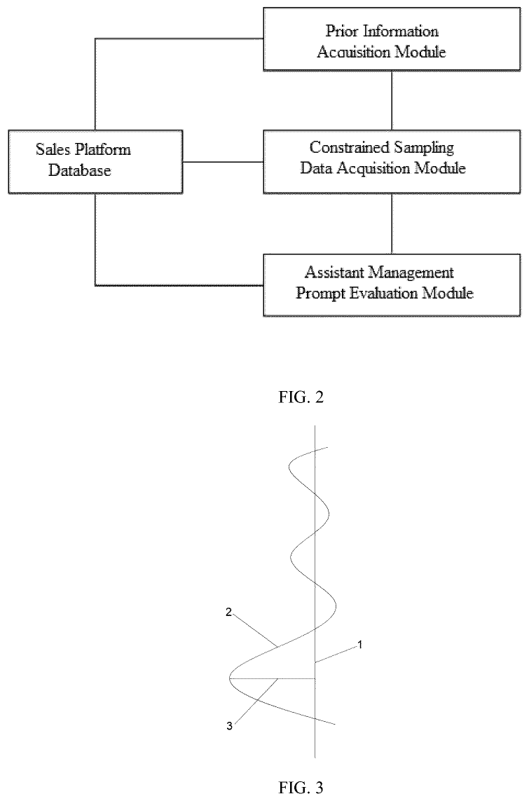

Referring to FIG. 2, the present invention provided a system of performing quality conformance sampling inspection of commodities based on prior information on the other hand, which included;

A prior information acquisition module, a constrained sampling data acquisition module, an assistant management prompt evaluation module and a sales platform database.

The prior information acquisition module could be utilized to obtain the sets of set of prior information of each commodity available on the platform and analyze the prior characteristic values of each commodity for sale.

The constrained sampling data acquisition module could be utilized to obtain the constrained sampling data of each commodity for sale through analysis according to the prior characteristic values of the said commodity.

The assistant management prompt evaluation module could be utilized to process and screen unqualified samples based on the constraint sampling data of each commodity for sale for providing intelligent assistant management prompts.

The sales platform database could be utilized to store the reference values required for sampling inspection and obtaining constrained sampling data of each commodity for sale based on prior information.

In the embodiments, the sales platform database included the defined ex-factory pass rate of quality inspection, the defined damage rate of production line, the defined return rate, the reference proportion of negative comments, the reference sales volume, and reference sales amount, the reference prior characteristic value, the reference prior characteristic values, the reference sampling increment and the reference increase threshold for passing inspection of the first inspected commodity within a range of prior characteristic deviation values, the preset sampling number and the preset evaluation threshold for passing sampling inspection of the second inspected commodity, the reference sampling decrement and the decrease threshold for passing inspection of the third inspected commodity within a range of prior characteristic deviation values, and the reference color value of collection point under each humidity inspection constraint condition, the defined length of and the reference contours of the deformed acquisition and inspection line under each temperature inspection constraint condition, as well as the weight of quality inspection validation, the reference offset of the center point position of the component and the reference total length of deviation of the outer edge contour as well as the evaluation threshold for passing sampling inspection.

It should be explained that the present invention established an appropriate method for performing quality conformance sampling inspection of commodities based on prior information according to the method for performing quality conformance sampling inspection of commodities based on prior information and its system described herein, which was able to analyze the sets of prior information of each commodity available on the sales platform, and thus contributed to accurately determining the historical defect degree of the said commodity. It facilitated the implementation of rational sampling optimization and enhancement based on the prior information of the commodity for sale, thereby improving the accuracy of performing quality conformance sampling inspection of each commodity for sale and the overall quality of the said commodity.

The foregoing is only an example and illustration of the construction of the present invention. Those skilled in the art may make various modifications or additions to the individual embodiment described, or replace it in a similar way. As long as they do not deviate from the structure of the invention, or exceed the limits defined in the present claims, they shall all fall within the protection of the present invention.

1. A method for performing quality conformance sampling inspection of commodities based on prior information, characterized in that consisting of:
obtaining a set of prior information of each commodity available on a sales platform, and analyzing prior characteristic values of each commodity for sale;
obtaining constrained sampling data of each commodity for sale through analysis of the prior characteristic values of each commodity for sale;
processing and screening an unqualified sampled commodity to provide intelligent assistant management prompts based on the constraint sampling data of each commodity for sale;
a set of prior information of each commodity for sale includes prior production data and prior marketing feedback data, wherein, the prior production data include an ex-factory pass rate of quality inspection and a damage rate of production line; in addition, the prior marketing feedback data include a return rate, average bytes of negative comments, a proportion of negative comments, a sales volume, and a sales amount generated during the prior period, and the average bytes of negative comments referred to average bytes of comments written by users among all negative comments, the average bytes of negative comments=a total bytes of negative comments/a number of negative comments;
the prior characteristic values of each commodity for sale, which are utilized to integrate and quantify the prior information of each commodity for sale, are obtained through comprehensive numerical analysis of the prior production data and the prior marketing feedback data of each commodity for sale, thereby providing the analysis basis for the constrained sampling data of each commodity for sale;
the analysis process of obtaining the constrained sampling data of each commodity for sale is as follows:
calculating a preset sampling number and a preset evaluation threshold for passing sampling inspection of each commodity for sale according to the prior characteristic values of each commodity for sale;
comparing the prior characteristic values of each commodity for sale with reference prior characteristic values stored in a sales platform database;
if the prior characteristic values of certain commodity for sale are lower than the reference prior characteristic values, such commodity shall be recorded as the first inspected commodity, and the prior characteristic deviation values of each first inspected commodity shall be calculated; then, by comparing the prior characteristic deviation values with a reference sampling increment and a reference increase threshold for passing inspection of the first inspected commodity within a range of prior characteristic deviation values stored in the sales platform database, the reference sampling increment and the reference increase threshold for passing inspection of each first inspected commodity are obtained, and the preset sampling number and the preset evaluation threshold for passing sampling inspection of each first commodity for sale shall be extracted; after that the fixed sampling number and the evaluation threshold for fixed samples passed inspection of each first inspected commodity, which are utilized as the constrained sampling data of the first inspected commodity, are obtained by accumulating an extracted preset sampling number and the preset evaluation threshold for passing sampling inspection successively;
if the prior characteristic values of certain commodity for sale are equal to the reference prior characteristic values, such commodity shall be recorded as the second inspected commodity, and the preset sampling number and the preset evaluation threshold for passing sampling inspection of a second inspected commodity, which are utilized as the constrained sampling data of the second inspected commodity, are obtained;
if the prior characteristic values of certain commodity for sale are larger than the reference prior characteristic values, such commodity shall be recorded as a third inspected commodity, and the prior characteristic deviation values of each third inspected commodity shall be calculated; then, by comparing the prior characteristic deviation values with a reference sampling decrement and a reference decrease threshold for passing inspection of the third inspected commodity within a range of prior characteristic deviation values stored in the sales platform database, a reference sampling decrement and a reference decrease threshold for passing inspection of the third inspected commodity are obtained, and the preset sampling number and the preset evaluation threshold for passing sampling inspection of each third commodity for sale shall be extracted; after that the fixed sampling number and the evaluation threshold for fixed samples passed inspection of each third inspected commodity, which are utilized as the constrained sampling data of the third inspected commodity, are obtained by subtracting the extracted preset sampling number and the preset evaluation threshold for passing sampling inspection of the third inspected commodity successively;
a specific process of processing and screening unqualified sampled commodity for providing intelligent assistant management prompts is as follows:
calculating the sampling inspection data of each first, second and third inspected commodity, respectively, which include the 3D scanning images of samples and the integrated quality inspection information of samples;
wherein, integrated quality inspection information of samples includes: color values of collection points under each humidity inspection constraint condition, lengths of and contours of the deformed acquisition and inspection line under each temperature inspection constraint condition, as well as the weights of quality inspection;
extracting the reference 3D scanning images of validation of each first, second and third inspected commodity from the sales platform database, and then, extracting the sets of sampling inspection difference of each first, second and third inspected commodity through comparison in sequence, including: an offset of the center point position of each component, a total length of deviation of the outer edge contour;
extracting quality inspection information of samples based on integrated comparison of each first, second and third inspected commodity from the sales platform database, including reference color values of collection points under each humidity inspection constraint condition, defined lengths of and the reference contours of the deformed acquisition and inspection line under each temperature inspection constraint condition, as well as the weights of quality inspection validation;
calculating maximum offset widths of the acquisition and inspection line of each first, second and third inspected commodity under each temperature inspection constraint condition through comparison of contours of the deformed acquisition and inspection line with the corresponding reference contours of the deformed line under each temperature inspection constraint condition;
completing numerical fitting processing according to the sets of sampling inspection difference, the integrated quality inspection information of samples, and the quality inspection information of samples based on integrated comparison of each first, second and third inspected commodity, and thus, evaluation values of sampling inspection qualified levels of the said first, second and third inspected commodity are obtained;
comparing the evaluation values of sampling inspection qualified levels of each first, second and third inspected commodity with the corresponding evaluation threshold for sampling inspection qualified levels; if the evaluation values of sampling inspection qualified levels of each first, second and third inspected commodity are lower than the corresponding evaluation threshold for sampling inspection qualified levels, such commodity shall be uniformly labelled as unqualified sampling commodity, thereby providing intelligent assistant management prompts; and
the commodity for sale is clothing, which consisted of pockets, buttons, and labels, the method further comprises: processing and screening an unqualified clothing based on the constraint sampling data of the clothing.

2. The method for performing quality conformance sampling inspection of commodities based on prior information according to claim 1, characterized in that the specific calculation formula for the prior characteristic values of each commodity for sale is:
$${λ}_{j} = \sqrt{{λ}_{j 1} * {v}_{1} + {λ}_{j 2} * {v}_{2}} ;$$
wherein, λⱼ represents the prior characteristic value of the jth commodity for sale, λⱼ₁ and λⱼ₂ represent the prior characteristic value of production and the prior characteristic value of marketing feedback of the jth commodity for sale respectively, in addition, v₁ and v₂ represent the weight factors of the given prior characteristic value of production and the prior characteristic value of marketing feedback, and j represents the serial number of each commodity for sale, i.e., j=1, 2, 3, . . . , j′, j′ represents the total number of commodity for sale.

3. The method for performing quality conformance sampling inspection of commodities based on prior information according to claim 2, characterized in that the prior characteristic value of production and the prior characteristic value of marketing feedback of the commodity for sale are respectively utilized to represent the quality status after commodity inspection and the satisfaction level of customers, thereby providing the analysis basis for the constrained sampling data of each commodity for sale.

4. The method for performing quality conformance sampling inspection of commodities based on prior information according to claim 1, characterized in that the computational formula of the evaluation values of sampling inspection qualified levels of each first, second and third inspected commodity is:
$$\{ \begin{matrix}{δ}_{i} = {α}_{i} * {τ}_{1} + {β}_{i} * {τ}_{2} \\ {δ}_{q} = {α}_{q} * {τ}_{3} + {β}_{q} * {τ}_{4} \\ {δ}_{n} = {α}_{n} * {τ}_{5} + {β}_{n} * {τ}_{6}\end{matrix} ;$$
wherein, δᵢ, δ_{q} and δₙ represent the evaluation values of sampling inspection qualified levels of the ith first inspected commodity, the qth second inspected commodity, and the nth third inspected commodity, respectively, βᵢ and αᵢ represent the evaluation values of the appearance and integrated inspection qualified level of the first inspected commodity i, respectively, β_{q} and α_{q} represent the evaluation values of the appearance and integrated inspection qualified level of the second inspected commodity q, respectively, in addition, βₙ and αₙ represent the evaluation values of the appearance and integrated inspection qualified level of the second inspected commodity n, respectively; τ₁ and τ₂ represent the given weight factors of the appearance and integrated inspection qualified level of the first inspected commodity, respectively, τ₃ and τ₄ represent the given weight factors of the appearance and integrated inspection qualified level of the second inspected commodity, respectively, τ₅ and τ₆ represent the given weight factors of the appearance and integrated inspection qualified level of the third inspected commodity, respectively; furthermore, i represents the serial number of each first inspected commodity, i.e., i=1, 2, 3, . . . , i′, and i′ represents the total number of the first inspected commodity, q represents the serial number of each second inspected commodity, i.e., q=1, 2, 3, . . . , q′, and q′ represents the total number of the second inspected commodity, in addition, n represents the serial number of each third inspected commodity, i.e., n=1, 2, 3, . . . , n′, and n′ represents the total number of the third inspected commodity.

5. The method for performing quality conformance sampling inspection of commodities based on prior information according to claim 4, characterized in that the evaluation values of the sampling inspection qualified levels of the first inspected commodity, which are utilized to integrate and quantify the sampling inspection qualified levels of the first inspected commodity, are obtained through comprehensive numerical analysis of the 3D scanning images and the quality inspection information of samples based on integrated comparison, thereby providing the analysis basis for determining the sampling inspection qualified levels of the first inspected commodity;
the evaluation values of the sampling inspection qualified levels of the second inspected commodity, which are utilized to integrate and quantify the sampling inspection qualified levels of the second inspected commodity, are obtained through comprehensive numerical analysis of the 3D scanning images and the quality inspection information of samples based on integrated comparison, thereby providing the analysis basis for determining the sampling inspection qualified levels of the second inspected commodity;
the evaluation values of the sampling inspection qualified levels of the third inspected commodity, which are utilized to integrate and quantify the sampling inspection qualified levels of the third inspected commodity, are obtained through comprehensive numerical analysis of the 3D scanning images and the quality inspection information of samples based on integrated comparison, thereby providing the analysis basis for determining the sampling inspection qualified levels of the third inspected commodity.

6. A system of quality conformance sampling inspection of commodities based on prior information, characterized in that consisting of:
a prior information acquisition module, which is utilized to obtain a set of prior information of each commodity available on a sales platform and analyze prior characteristic values of each commodity for sale;
a constrained sampling data acquisition module, which is utilized to obtain the constrained sampling data of each commodity for sale through analysis according to the prior characteristic values of the commodity;
an assistant management prompt evaluation module, which is utilized to process and screen unqualified samples based on the constraint sampling data of each commodity for sale for providing intelligent assistant management prompts, and the commodity for sale is clothing, which consisted of pockets, buttons, and labels, the assistant management prompt evaluation module further configured to: processing and screening an unqualified clothing based on the constraint sampling data of the clothing;
a sales platform database, which is utilized to store the reference prior characteristic values, a reference sampling increment and a reference increase threshold for passing inspection of a first inspected commodity within a range of prior characteristic deviation values, a preset sampling number and a preset evaluation threshold for passing sampling inspection of a second inspected commodity, a reference sampling decrement and a decrease threshold for passing inspection of a third inspected commodity within a range of prior characteristic deviation values, and a reference color value of collection point under each humidity inspection constraint condition, a defined length of and reference contours of a deformed acquisition and inspection line under each temperature inspection constraint condition, as well as a weight of quality inspection validation and an evaluation threshold for passing sampling inspection;
a set of prior information of each commodity for sale includes prior production data and prior marketing feedback data, wherein, the prior production data include an ex-factory pass rate of quality inspection and a damage rate of production line; in addition, the prior marketing feedback data include a return rate, average bytes of negative comments, a proportion of negative comments, a sales volume, and a sales amount generated during a prior period;
prior characteristic values of each commodity for sale, which are utilized to integrate and quantify prior information of each commodity for sale, are obtained through comprehensive numerical analysis of the prior production data and the prior marketing feedback data of each commodity for sale, thereby providing an analysis basis for constrained sampling data of each commodity for sale;
an analysis process of obtaining the constrained sampling data of each commodity for sale is as follows:
calculating a preset sampling number and a preset evaluation threshold for passing sampling inspection of each commodity for sale according to the prior characteristic values of each commodity for sale;
comparing the prior characteristic values of each commodity for sale with the reference prior characteristic values stored in the sales platform database;
if the prior characteristic values of certain commodity for sale are lower than the reference prior characteristic values, such commodity shall be recorded as a first inspected commodity, and prior characteristic deviation values of each first inspected commodity shall be calculated; then, by comparing the prior characteristic deviation values with a reference sampling increment and a reference increase threshold for passing inspection of the first inspected commodity within a range of prior characteristic deviation values stored in the sales platform database, a reference sampling increment and a reference increase threshold for passing inspection of each first inspected commodity are obtained, and the preset sampling number and the preset evaluation threshold for passing sampling inspection of each first commodity for sale shall be extracted; after that the fixed sampling number and the evaluation threshold for fixed samples passed inspection of each first inspected commodity, which are utilized as the constrained sampling data of the first inspected commodity, are obtained by accumulating the extracted preset sampling number and the preset evaluation threshold for passing sampling inspection successively;
if the prior characteristic values of certain commodity for sale are equal to the reference prior characteristic values, such commodity shall be recorded as a second inspected commodity, and the preset sampling number and a preset evaluation threshold for passing sampling inspection of the second inspected commodity, which are utilized as the constrained sampling data of the second inspected commodity, are obtained;
if the prior characteristic values of certain commodity for sale are larger than the reference prior characteristic values, such commodity shall be recorded as a third inspected commodity, and the prior characteristic deviation values of each third inspected commodity shall be calculated; then, by comparing the prior characteristic deviation values with a reference sampling decrement and a reference decrease threshold for passing inspection of the third inspected commodity within a range of prior characteristic deviation values stored in the sales platform database, a reference sampling decrement and a reference decrease threshold for passing inspection of the third inspected commodity are obtained, and the preset sampling number and the preset evaluation threshold for passing sampling inspection of each third commodity for sale shall be extracted; after that the fixed sampling number and the evaluation threshold for fixed samples passed inspection of each third inspected commodity, which are utilized as the constrained sampling data of the third inspected commodity, are obtained by subtracting the extracted preset sampling number and the preset evaluation threshold for passing sampling inspection of the third inspected commodity successively;
a specific process of processing and screening unqualified sampled commodity for providing intelligent assistant management prompts is as follows:
calculating the sampling inspection data of each first, second and third inspected commodity, respectively, which include the 3D scanning images of samples and the integrated quality inspection information of samples;
wherein, integrated quality inspection information of samples includes: color values of collection points under each humidity inspection constraint condition, lengths of and contours of the deformed acquisition and inspection line under each temperature inspection constraint condition, as well as the weights of quality inspection;
extracting a reference 3D scanning images of validation of each first, second and third inspected commodity from the sales platform database, and then, extracting sets of sampling inspection difference of each first, second and third inspected commodity through comparison in sequence, including: an offset of the center point position of each component, a total length of deviation of the outer edge contour;
extracting a quality inspection information of samples based on integrated comparison of each first, second and third inspected commodity from the sales platform database, including a reference color values of collection points under each humidity inspection constraint condition, the defined lengths of and the reference contours of the deformed acquisition and inspection line under each temperature inspection constraint condition, as well as the weights of quality inspection validation;
calculating maximum offset widths of the acquisition and inspection line of each first, second and third inspected commodity under each temperature inspection constraint condition through comparison of the deformed acquisition and inspection line with the corresponding reference contours of the deformed line under each temperature inspection constraint condition;
completing numerical fitting processing according to the sets of sampling inspection difference, the integrated quality inspection information of samples, and the quality inspection information of samples based on integrated comparison of each first, second and third inspected commodity, and thus, evaluation values of sampling inspection qualified levels of the said first, second and third inspected commodity are obtained;
comparing the evaluation values of sampling inspection qualified levels of each first, second and third inspected commodity with the corresponding evaluation threshold for sampling inspection qualified levels; if the evaluation values of sampling inspection qualified levels of each first, second and third inspected commodity are lower than the corresponding evaluation threshold for sampling inspection qualified levels, such commodity shall be uniformly labelled as unqualified sampling commodity, thereby providing intelligent assistant management prompts; and
the commodity for sale is clothing, which consisted of pockets, buttons, and labels, the method further comprises: processing and screening an unqualified clothing based on the constraint sampling data of the clothing.
